(19) United States
(12) Patent Application Publication
(10) Pub. No.: US 2009/0306314 A1
(43) Pub. Date: Dec. 10, 2009

(54) METHOD FOR PRODUCING OLEFIN POLYMER

(75) Inventors: Masashi Hamba, Ichihara-shi (JP); Tomoaki Goto, Kisarazu-shi (JP)

Correspondence Address: BIRCH STEWART KOLASCH & BIRCH, PO BOX 747, FALLS CHURCH, VA, 22040-0747, US

(73) Assignee: SUMITOMO CHEMICAL COMPANY, LIMITED, Tokyo (JP)

(21) Appl. No.: 12/097,738

(22) PCT Filed: Dec. 18, 2006
(86) PCT No.: PCT/JP2006/325678

§ 371 Date: Sep. 18, 2008

(30) Foreign Application Priority Data
Dec. 19, 2005 (JP) 2005-364438

(51) Int. Cl. C08F 4/44

(52) U.S. Cl. 526/78; 526/160; 526/943

(57) ABSTRACT

In a method for producing an olefin polymer to polymerize olefin by supplying olefin and a catalyst for polymerizing olefin into a vapor-phase fluidized bed reactor, the method includes introducing a fluidity improving agent comprising a compound represented by the following formula into the vapor-phase fluidized bed reactor.

[R—O—(AO)m—COO—]nY

(wherein, R represents an alkyl group, an alkenyl group or an aryl group, AO represents an alkylene oxide group, m represents the average addition molar number of alkylene oxide, Y represents a hydrogen atom, an alkali metal atom, an alkaline earth metal atom or an ammonium group, and n represents the valence of Y.)

### TECHNICAL FIELD

The present invention relates to a method for producing an olefin polymer using a vapor-phase fluidized bed polymerization reactor.

### CONVENTIONAL ART

A method for producing an olefin polymer using a vapor-phase fluidized bed polymerization method does not need a polymer depositing step and a solvent separating step, which are carried out after polymerizing, comparing with a production method using a solution polymerization method or a slurry polymerization method, and thus is known to be capable of simplifying a production process. The publicly known method for producing an olefin polymer using a vapor-phase fluidized bed polymerization method polymerizes olefin by the steps of blowing olefin-containing gas into a vapor-phase fluidized bed reactor, and floating and fluidizing polyolefin particles in the vapor-phase fluidized reactor (with forming a so-called fluidized bed). However, in this method, fluidity of polyolefin particles is decreased during polymerization so that a mixing state of the fluidized bed becomes uneven. Thus, this method has a problem in long-term stability for the production.

For example, Unexamined Japanese Patent Publication No. 2000-313717 discloses a method for suppressing decreasing of the fluidity of polyolefin particles by supplying lauryldiethanolamide into a vapor-phase fluidized bed reactor.

However, this method may cause decreasing polymerization activity, and thus is not fully satisfactory.

### DISCLOSURE OF THE INVENTION

An objective of the present invention is to provide a method for producing an olefin polymer using a vapor-phase fluidized bed reactor, which can make proper fluidity of polyolefin particles and polymerization activity.

That is, the present invention relates to a method for producing an olefin polymer by supplying olefin and a catalyst for polymerizing olefin into a vapor-phase fluidized bed reactor, and the method further includes the step of introducing a fluidity improving agent containing a compound represented by the following formula into the vapor-phase fluidized bed reactor.

[R—O—(AO)m—COO—]nY

(wherein, R represents an alkyl group, an alkenyl group, or an aryl group, AO represents an alkylene oxide group, m represents an average addition molar number of alkylene oxide, Y represents a hydrogen atom, an alkali metal atom, an alkaline earth metal atom, or an ammonium group, and n represents the valence of Y.)

### PREFERRED EMBODIMENTS FOR CARRYING OUT OF THE INVENTION

In the present invention, “a polymerization” includes not only an independent polymerization but also a copolymerization, and “a polymer” includes not only an independent polymer but also a copolymer.

In the present invention, olefin and a catalyst for polymerizing olefin are supplied into a vapor-phase fluidized bed reactor, and the olefin is polymerized in the vapor-phase fluidized bed reactor in the presence of the catalyst for polymerizing olefin. As for the vapor-phase fluidized bed reactor used in the present invention, a publicly known vapor-phase fluidized bed reactor can be used. For example, such the vapor-phase fluidized bed reactors are disclosed in Unexamined Japanese Patent Publication No. S58-201802, Unexamined Japanese Patent Publication No. S59-126406, Unexamined Japanese Patent Publication No. H2-233708, Unexamined Japanese Patent Publication No. H4-234409, and Unexamined Japanese Patent Publication No. H7-62009.

The present invention polymerizes olefin by introducing a fluidity improving agent containing polyalkyleneoxidealkyl ether acetate represented by the following formula or its salt into a vapor-phase fluidized bed reactor. One or more kinds of the fluidity improving agents are used.

[R—O—(AO)m—COO—]nY

(wherein, R represents an alkyl group, an alkenyl group, or an aryl group, AO represents an alkylene oxide group, m represents an average addition molar number of alkylene oxide, Y represents a hydrogen atom, an alkali metal atom, an alkaline earth metal atom, or an ammonium group, and n represents the valence of Y.)

The alkyl group of R includes a lauryl group, a cetyl group, a stearyl group, an octyl group, and a sec-lauryl group. The alkenyl group of R includes an oleyl group, and the aryl group includes a nonylphenyl group. The carbon number of R is ordinarily 1 to 30, preferably 6 to 20, and more preferably 8 to 18. The alkyl group is preferable as R, and the lauryl group is more preferable.

The alkylene oxide group of AO includes ethylene oxide and propylene oxide, and ethylene oxide is preferable. Further, the average addition molar number of alkylene oxide of m is ordinarily 2 to 30, preferably 3 to 20, and more preferably 4 to 10.

Y represents a hydrogen atom, an alkali metal atom, an alkaline earth metal atom, or an ammonium group. The alkali metal atom includes a lithium atom, a sodium atom, and a potassium atom. The alkaline earth metal atom includes a beryllium atom, a magnesium atom, a calcium atom. A sodium atom, a magnesium atom, a potassium atom, and a calcium atom are preferable, and a sodium atom is more preferable.

The n represents the valence of Y. For example, when Y is a hydrogen atom, an alkali metal atom such as a sodium atom or a potassium atom, or an ammonium group, the valence is 1. When Y is an alkaline earth metal atom such as a magnesium atom or a calcium atom, the valence is 2.

The polyalkyleneoxidealkyl ether acetate or its salt includes, for example, polyoxyethylenelauryl ether acetate, polyoxyethylenelauryl ether sodium acetate, polyoxyethylenecetyl ether acetate, polyoxyethylenecetyl ether sodium acetate, polyoxyethylenestearyl ether acetate, polyoxyethylenestearyl ether sodium acetate, polyoxyethyleneoctyl ether acetate, polyoxyethyleneoctyl ether sodium acetate, polyoxyethylenenonylphenyl ether acetate, and polyoxyethylenenonylphenyl ether sodium acetate. Among those, polyoxyethylenelauryl ether acetate and polyoxyethylenelauryl ether sodium acetate are preferable.

The amount of the fluidity improving agent introduced into the vapor-phase fluidized bed reactor is ordinarily 0.01 to 1000 ppm by weight with respect to the total weight of a polymer in a fluidized bed. In order to increase fluidity, the amount of the fluidity improving agent is preferably not less than 0.1 ppm by weight, more preferably not less than 1 ppm by weight, and further more preferably not less than 5 ppm by weight. Further, in order to increase polymerization activity, the amount of the fluidity improving agent is preferably not more than 400 ppm by weight, more preferably not more than 300 ppm by weight, and further more preferably not more than 200 ppm by weight.

Methods for introducing a fluidity improving agent into a vapor-phase fluidized bed reactor are (1) a method to coat a fluidity improving agent on an inner face of a vapor-phase fluidized bed reactor, (2) a method to introduce polymer particles containing a fluidity improving agent into a vapor-phase fluidized bed reactor, and (3) a method to introduce a liquid containing a fluidity improving agent into a vapor-phase fluidized bed reactor. Further, in the methods of (2) and (3), a fluidity improving agent can be introduced intermittently or continuously.

In the method of (1) to coat a fluidity improving agent on an inner face of a vapor-phase fluidized bed reactor, a fluidity improving agent is coated on a reactor inner wall face contacting a fluidized bed and/or a gas dispersion plate. An area in which the agent is coated is preferably not less than 5% of a total area of the reactor inner wall face contacting a fluidized bed and the gas dispersion plate (where the total area is 100%), more preferably not less than 25%, further more preferably not less than 50%, and particular preferably not less than 90%.

As for the coating amount of the fluidity improving agent, the amount of the fluidity improving agent in the vapor-phase fluidized bed reactor is preferably not less than 0.01 ppm by weight with respect to the total weight of a polymer in a fluidized bed in order to increase fluidity. Further, in order to increase polymerization activity, the amount of the fluidity improving agent in the vapor-phase fluidized bed reactor is preferably not more than 1000 ppm by weight with respect to the total weight of a polymer in a fluidized bed.

When the fluidity improving agent is coated, only a fluidity improving agent can be coated on the inner face, and a liquid (a solution, a dispersion liquid, or the like) obtained by diluting a fluidity improving agent with a proper solvent such as a hydrocarbon solvent or alcohol can be coated. In this case, it is preferable to remove the solvent by drying the inside of the reactor after coating the liquid.

In the method of (2) to introduce polymer particles containing a fluidity improving agent into a vapor-phase fluidized bed reactor, a polymer used for preparing polymer particles containing a fluidity improving agent is preferably the same polymer as a polymer to be produced. For example, the polymer is a polyolefin resin such as polyethylene or polypropylene.

The content of the fluidity improving agent in the polymer particles containing a fluidity improving agent is ordinarily 10 to 100000 ppm by weight with respect to the weight of a polymer in the polymer particles containing a fluidity improving agent. In order to increase fluidity and economical efficiency, the content is preferably 100 to 50000 ppm by weight, and more preferably 200 to 20000 ppm by weight.

A weight average particle diameter of the polymer particles containing a fluidity improving agent is ordinarily 350 to 3000 μm, and preferably 400 to 2000 μm. A bulk density is ordinarily 0.25 to 0.50 g/cm³, and preferably 0.30 to 0.45 g/cm³. In addition, the weight average particle diameter is measured by a laser diffraction-type particle size distribution measuring apparatus (for example, HELOS&RODOS, produced by JEOL Ltd.), and the bulk density is measured using a bulk density measuring apparatus according to JIS K6721-1977.

Methods for preparing polymer particles containing a fluidity improving agent are \textcircled{1} a method to mix polymer particles and a fluidity improving agent, \textcircled{2} a method to spray a fluidity improving agent to polymer particles, and \textcircled{3} a method including steps of melting and kneading a polymer and a fluidity improving agent and pulverizing it so as to make particles. The method of \textcircled{1} to mix polymer particles and a fluidity improving agent uses publicly known mixers, e.g., a V-type mixer such as a V-blender, a ribbon-type mixer such as a ribbon blender, a tumbler-type mixer such as a tumbler blender, and an agitation mixer with an oscillator such as a Henschel mixer. Further, in the method of \textcircled{2} to spray a fluidity improving agent to polymer particles, only a fluidity improving agent can be sprayed on polymer particles, or a liquid (a solution, a dispersion liquid, or the like) obtained by diluting a fluidity improving agent with a proper solvent such as a hydrocarbon solvent or alcohol can be sprayed on polymer particles so as to be fully dried.

As for a position to introduce the polymer containing the fluidity improving agent, a fluidized bed in a vapor-phase fluidized bed reactor is preferable.

In the method of (3) to introduce a liquid containing a fluidity improving agent into a vapor-phase fluidized bed reactor, a liquid (a solution, a dispersion liquid, or the like) obtained by diluting a fluidity improving agent with a particular solvent such as a hydrocarbon solvent such as pentane, hexane, or heptane can be used as the liquid containing a fluidity improving agent.

As for a position to introduce the liquid containing a fluidity improving agent, the liquid can be directly introduced to the vapor-phase fluidized bed reactor, or can be introduced into a circulation gas line so as to be indirectly introduced from a bottom part of the vapor-phase fluidized bed reactor. However, it is preferable to directly introduce the liquid into a fluidized bed in the vapor-phase fluidized bed reactor.

When there is a problem in fluidity of seed polymer particles before beginning a polymerization of olefin in a vapor-phase fluidized bed reactor, it is preferable to use the following methods. That is, the method of (1) to coat a fluidity improving agent on an inner face of a vapor phase fluidized bed reactor, a method to use seed polymer particles produced by mixing the total amount or a part of polymer particles containing a fluidity improving agent in the method of (2), and a method to introduce a liquid containing a fluidity improving agent into a fluidized bed of seed polymer particles before beginning a polymerization in the method of (3).

As for the catalyst for polymerizing olefin, a publicly known polymerizing catalyst used for polymerizing olefin in a vapor-phase fluidized bed reactor can be used. For example, the polymerizing catalyst includes a catalyst obtained by contacting a solid catalyst component (a) containing titanium, magnesium, and halogen to an organic aluminum compound (this catalyst will be called as a solid catalyst (A) below); a catalyst obtained by supporting a cocatalyst and a metallocene based compound on particulate support, where the cocatalyst is an organic aluminum compound, an organic aluminumoxy compound, or a boron compound (this catalyst will be called as a solid catalyst (B) below); and a catalyst obtained by contacting a metallocene based compound to a solid catalyst component (c) which is obtained by supporting a cocatalyst on particulate support, where the cocatalyst is an organic aluminum compound, an organic aluminumoxy compound, a boron compound, or an organic zinc compound (this catalyst will be called as a solid catalyst (C) below).

The particulate support is preferably a porous material, and includes inorganic oxides such as SiO₂, Al₂O₃, MgO, ZrO₂, TiO₂, B₂O₃, CaO, ZnO, BaO and ThO₂; clays or clay materials such as smectite, montmorillonite, hectorite, raponite, and saponite; and organic polymers such as polyethylene, polypropylene, and a styrene-divinylbenzene copolymer.

An average particle diameter of the particulate support is preferably 5 to 1000 μm, more preferably 10 to 500 μm, and further more preferably 10 to 100 μm. A fine pore capacity is preferably not less than 0.1 ml/g, and more preferably 0.3 to 10 ml/g. A specific surface area is preferably 10 to 1000 m²/g, and more preferably 100 to 500 m²/g.

The organic aluminum compound includes trimethylaluminum, triethylaluminum, trinormalbutylaluminum, triisobutylaluminum, trinormalhexylaluminum, diisobutylhexylaluminum, diisobutyloctylaluminum, isobutyldihexylaluminum, or isobutyldioctylaluminum.

The organic aluminumoxy compound includes tetramethyldialuminoxane, tetraethyldiaminoxane, tetrabutyldialuminoxane, tetrahexyldialuminoxane, methylaluminoxane, ethylaluminoxane, butylaluminoxane, isobutylaluminoxane, or hexylaluminoxane, and a mixture of those can be used. Further, as for commercial organic aluminumoxy compounds, compounds produced by TOSOH FINECHEM CORPORATION, such as PMAO, TMAO, MMAO, and PBAO, can be used.

The boron compound includes tris(pentafluorophenyl)borane, triphenylcarbeniumtetrakis(pentafluorophenyl)borate, tri(n-butyl)ammoniumtetrakis(pentafluorophenyl)borate, or N,N-dimethylaniliniumtetrakis(pentafluorophenyl)borate.

The organic zinc compound includes dialkylzinc such as dimethylzinc, diethylzinc, dipropylzinc, di-n-butylzinc, diisobutylzinc, or di-n-hexylzinc; a diarylzinc such as diphenylzinc, dinaphthylzinc, or bis(pentafluorophenyl)zinc; dialkenylzinc such as diarylzinc; bis(cyclopentadienyl)zinc; and halogenated alkylzinc such as methylzinc chloride, ethylzinc chloride, propylzinc chloride, n-butylzinc chloride, isobutylzinc chloride, n-hexylzinc chloride, methylzinc bromide, ethylzinc bromide, propylzinc bromide, n-butylzinc bromide, isobutylzinc bromide, n-hexylzinc bromide, methylzinc iodide, ethylzinc iodide, propylzinc iodide, n-butylzinc iodide, isobutylzinc iodide, or n-hexylzinc iodide.

The metallocene based compound is a transition metal compound including a ligand having a cyclopentadienyl skeleton. For example, the transition metal compound represented by the following formula [1] can be used.

LₐMXₚ₋ₐ [1]

(wherein, M represents transition metal, p represents the number satisfying the atomic valence of the transition metal M, a represents the number satisfying 0<a≦p, L represents a ligand having a cyclopentadienyl skeleton and coordinating to the transition metal, X represents a group containing a halogen atom, a hydrocarbon atom (not including a group having a cyclopentadienyl-shaped anion skeleton in this case), and a hetero atom).)

The transition metal M of the formula [1] is preferably an atom of the group 3 to the group 6 in the periodic table of elements (IUPAC 1989), and titanium, zirconium, and hafnium are more preferable.

a in the formula [1] represents the number satisfying 0<a≦p, and p represents the number satisfying the atomic valence of the transition metal M. When M is a titanium atom, a zirconium atom, or a hafnium atom, p is preferably 2.

The ligand having a cyclopentadienyl skeleton of L includes a (substituted) cyclopentadienyl group, a (substituted) indenyl group and a (substituted) fluorenyl group. More particularly, the ligand includes a cyclopentadienyl group, a methylcyclopentadienyl group, a tert-butylcyclopentadienyl group, a dimethylcyclopentadienyl group, a tert-butyl-methylcyclopentadienyl group, a methyl-isopropylcyclopentadienyl group, a trimethylcyclopentadienyl group, a tetramethylcyclopentadienyl group, a pentamethylcyclopentadienyl group, an indenyl group, a 4,5,6,7-tetrahydroindenyl group, a 2-methylindenyl group, a 3-methylindenyl group, a 4-methylindenyl group, a 5-methylindenyl group, a 6-methylindenyl group, a 7-methylindenyl group, a 2-tert-butylindenyl group, a 3-tert-butylindenyl group, a 4-tert-butylindenyl group, a 5-tert-butylindenyl group, a 6-tert-butylindenyl group, a 7-tert-butylindenyl group, a 2,3-dimethylindenyl group, a 4,7-dimethylindenyl group, a 2,4,7-trimethylindenyl group, a 2-methyl-4-isopropylindenyl group, a 4,5-benzindenyl group, a 2-methyl-4,5-benzindenyl group, a 4-phenylindenyl group, a 2-methyl-5-phenylindenyl group, a 2-methyl-4-phenylindenyl group, a 2-methyl-4-naphthylindenyl group, a fluorenyl group, a 2,7-dimethylfluorenyl group, a 2,7-di-tert-butylfluorenyl group, and a substituent of those. Further, when there are two or more ligands having a cyclopentadienyl skeleton, these ligands can be the same or different each other.

A particular example of a halogen atom of X includes a fluorine atom, a chlorine atom, a bromine atom, and an iodine atom. The hydrocarbon atom includes an alkyl group, an aralkyl group, an aryl group, and an alkenyl group. The hetero atom in a group containing a hetero atom includes an oxygen atom, a sulfur atom, a nitrogen atom, and a phosphorus atom. An example of the group containing a hetero atom includes an alkoxy group; an aryloxy group; a thioalkoxy group; a thioaryloxy group; an alkylamino group; an arylamino group; an alkylphosphino group; an arylphosphino group; and an aromatic or fatty heterocyclic group having at least one atom selected from an oxygen atom, a sulfur atom, a nitrogen atom, and a phosphorus atom in the ring.

When there are two or more ligands having a cyclopentadienyl skeleton, these ligands having a cyclopentadienyl skeleton can be directly connected and be connected through a residue containing at least one kind of an atom selected from a carbon atom, a silicon atom, a nitrogen atom, an oxygen atom, a sulfur atom, and a phosphorus atom. Further, the ligands having a cyclopentadienyl skeleton and X can be directly connected, and can be connected through a residue containing at least one kind of an atom selected from a carbon atom, a silicon atom, a nitrogen atom, an oxygen atom, a sulfur atom, and a phosphorus atom. An example of the residue includes alkylene groups such as a methylene group, an ethylene group, and a propylene group; substituted alkylene groups such as a dimethylmethylene group (an isopropylidene group), and a diphenylmethylene group; a silylene group; substituted silylene groups such as a dimethylsilylene group, a diethylsilylene group, a diphenylsilylene group, a tetramethyldisilylene group, and a dimethoxysilylene group; and hetero atoms such as a nitrogen atom, an oxygen atom, a sulfur atom, and a phosphorous atom. A methylene group, an ethylene group, a dimethylmethylene group (an isopropylidene group), a diphenylmethylene group, a dimethylsilylene group, a diethylsilylene group, a diphenylsilylene group, or a dimethoxysilylene group is particularly preferable.

The transition metal compound containing a ligant having a cyclopentadienyl skeleton includes cyclopentadienyl zirconium dichloride, bis(1,3-n-butylmethylcyclopentadienyl) zirconium dichloride, bis(1,3-n-propylmethylcyclopentadienyl) zirconium dichloride, bis(n-butylcyclopentadienyl) zirconium dichloride, bis(1,3-dimethylcyclopentadienyl) zirconium dichloride, bis(1,3-diethylcyclopentadienyl) zirconium dichloride, ethylenebis(indenyl) zirconium dichloride, ethylenebis(4-methyl-1-indenyl) zirconium dichloride, and ethylenebis(4,5,6,7-tetrahydro-1-indenyl) zirconium dichloride.

As for the solid catalyst component (a), solid catalyst components disclosed in Unexamined Japanese Patent Publication No. S63-142008, Unexamined Japanese Patent Publication No. H4-227604, Unexamined Japanese Patent Publication No. H5-339319, Unexamined Japanese Patent Publication No. H6-179720, Japanese Patent Kokoku No. H7-116252, Unexamined Japanese Patent Publication No. H8-134124, Unexamined Japanese Patent Publication No. H9-31119, Unexamined Japanese Patent Publication No. H11-228628, Unexamined Japanese Patent Publication No. H11-80234, and Unexamined Japanese Patent Publication No. H11-322833, can be used. Further, when the solid catalyst (A) is prepared, an electron donating compound can contact the solid catalyst component (a) and the organic aluminum compound if necessary.

As for the solid catalyst (B), solid catalysts disclosed in Unexamined Japanese Patent Publication No. S61-108610, Unexamined Japanese Patent Publication No. S61-296008, Unexamined Japanese Patent Publication No. S63-89505, Unexamined Japanese Patent Publication No. H3-234709, and Unexamined Japanese Patent Publication No. H6-336502 can be used.

As for the solid catalyst component (c), solid catalyst components disclosed in Unexamined Japanese Patent Publication No. 2003-171412, Unexamined Japanese Patent Publication No. 2003-171415, and Unexamined Japanese Patent Publication No. 2005-68170 can be used. Further, when the solid catalyst (C) is prepared, a cocatalyst component such as an organic aluminum compound can contact the solid catalyst component (c) and the metallocene compound if necessary.

The solid catalyst can be made by polymerizing few amounts of olefin (this polymerization will be called as a prepolymerization below). When a prepolymerized solid catalyst is used, the prepolymerization amount of olefin is ordinarily 0.01 to 1000 g per 1 g of a solid catalyst component in a solid catalyst, preferably 0.05 to 500 g, and particular preferably 0.1 to 200 g.

As for the catalyst for polymerizing olefin, a catalyst using a metallocene based compound as a catalyst component, that is, a metallocene based catalyst (the solid catalyst (B), the solid catalyst (C), or the like) is preferable.

When the catalyst for polymerizing olefin is supplied into the vapor-phase fluidized bed reactor, a catalyst obtained by contacting all catalyst components can be introduced into the vapor-phase fluidized bed reactor, a catalyst can be obtained by separately introducing catalyst components into the vapor-phase fluidized bed reactor and contacting these catalyst components in the vapor-phase fluidized bed reactor, and a catalyst can be obtained in the vapor-phase fluidized bed reactor by separately introducing a component, in which catalyst components are partially pre-contacted, and a catalyst component into the vapor-phase fluidized bed reactor.

Olefin used in the present invention includes 2-20C α-olefin, diolefin, cycloolefin, alkenyl aromatic hydrocarbon, and the like. Particularly, 2-20C α-olefin is preferable. Further, two or more olefins can be used.

A particular example of olefin includes α-olefins such as ethylene, propylene, 1-butene, 1-pentene, 4-methyl-1-pentene, 5-methyl-1-hexene, 1-hexene, 1-heptene, 1-octene, 1-nonene, and 1-decene; diolefins such as 1,5-hexadiene, 1,4-hexadiene, 1,4-pentadiene, 1,7-octadiene, 1,8-nonadiene, 1,9-decadiene, 4-methyl-1,4-hexadiene, 5-methyl-1,4-hexadiene, 7-methyl-1,6-octadiene, 5-ethylidene-2-norbornene, dicyclopentadiene, 5-vinyl-2-norbornene, 5-methyl-2-norbornene, norbornadiene, 5-methylene-2-norbornene, 1,5-cyclooctadiene, 5,8-endomethylenehexahydronaphthalene, 1,3-butadiene, isoprene, 1,3-hexadiene, 1,3-octadiene, 1,3-cyclooctadiene, and 1,3-cyclohexadiene; cycloolefins such as norbornene, 5-methylnorbornene, 5-ethylnorbornene, 5-butylnorbornene, 5-phenylnorbornene, 5-benzylnorbornene, tetracyclododecene, tricyclodecene, tricycloundecene, pentacyclopentadecene, pentacyclohexadecene, 8-methyltetracyclododecene, 8-ethyltetracyclododecene, 5-acetylnorbornene, 5-acetyloxynorbornene, 5-methoxycarbonylnorbornene, 5-ethoxycarbonylnorbornene, 5-methyl-5-methoxycarbonylnorbornene, 5-cyanonorbornene, 8-methoxycarbonyltetracyclododecene, 8-methyl-8-tetracyclododecene, and 8-cyanotetracyclododecene; and alkenyl aromatic hydrocarbons such as alkenylbenzenes, e.g., styrene, 2-phenylpropylene, 2-phenylbutene, and 3-phenylpropylene, alkylstyrenes, e.g., p-methylstyrene, m-methylstyrene, o-methylstyrene, p-ethylstyrene, m-ethylstyrene, o-ethylstyrene, 2,4-dimethylstyrene, 2,5-dimethylstyrene, 3,4-dimethylstyrene, 3,5-dimethylstyrene, 3-methyl-5-ethylstyrene, p-tertiary butylstyrene, and p-secondary butylstyrene, bisalkenylbenzene, e.g., divinylbenzene, and alkenylnaphthalene, e.g., 1-vinylnaphthalene.

A particular example of a combination when using two or more kinds of olefins includes ethylene and propylene, ethylene and 1-butene, ethylene and 1-hexene, ethylene and 4-methyl-1-pentene, ethylene and 1-octene, propylene and 1-butene, ethylene and propylene and 1-butene, ethylene and propylene and 1-hexene, ethylene and 1-butene and 1-hexene, and ethylene and 1-butene and 4-methyl-1-pentene.

As for conditions for polymerizing olefin, a polymerization temperature is ordinarily 30 to 110° C., and preferably 60 to 100° C. A polymerization pressure can be within a range in which olefin can exist as a vapor phase in a fluidized bed reactor. The pressure is ordinarily 0.1 to 5.0 MPa, and preferably 1.5 to 3.0 MPa. Further, a gas flow rate in a reactor is ordinarily 10 to 100 cm/sec., and preferably 20 to 70 cm/sec.

In a polymerization of olefin, hydrogen can be added as a molecular weight modifier in order to modify the molecular weight of an olefin polymer to be obtained. Further, olefin-containing gas blowing into the vapor-phase fluidized bed reactor can coexist with an inert gas. The molecular weight of the olefin polymer can be controlled by publicly known various means such as controlling of a temperature of a reaction zone, introducing of hydrogen and the like.

A particularly preferable olefin polymer produced in the present invention is a copolymer of ethylene and 3-20C α-olefin, and a copolymer of ethylene having a polyethylene crystal structure and 3-20C α-olefin is preferable. It is more preferable that the α-olefin is 3-8C α-olefin, and a particular example includes 1-butene, 1-hexene, 4-methyl-1-pentene, or 1-octene.

The present invention can provide a method for producing an olefin polymer by a vapor-phase fluidized bed reactor, and this method can provide an olefin polymer having proper fluidity of polyolefin particles and proper polymerization activity. The present invention is properly used for producing an olefin polymer using a metallocene based catalyst. Further, the present invention is used for producing an olefin polymer having a large molecular weight distribution, for example, an olefin polymer having a molecular weight distribution of 3 to 30.

### EXAMPLES

The present invention will be described in detail with reference to examples and comparative examples.

### Example 1

### (1) Synthesis of a Solid Catalyst Component

A solid component (it will be described as a solid catalyst component (1) below) was obtained by a similar method for synthesizing a component (A) in Example 1 disclosed in Unexamined Japanese Patent Publication No. 2005-68170.

### (2) Preparation of a Prepolymerization Catalyst

The solid catalyst component (1) of Example 1 (1) of 703 g was taken into an autoclave having an agitator, an inner capacity of 210 l, and being previously substituted by nitrogen. Then, butane of 80 l and hydrogen of 2 l (at ordinary temperature and ordinary pressure) were taken into the autoclave, and the autoclave was heated up to 30° C. Ethylene of 0.1 kg was taken in. After the inside of the system was stabilized, triisobutylaluminum of 210 mmol and racemic-ethylenebis(1-indenyl)zirconiumdiphenoxide of 69 mmol were taken in, and then a prepolymerization was begun. After beginning the prepolymerization, a polymerization temperature in a vessel was increased from 30° C. to 50° C. for 1 hour. Ethylene of 0.7 kg/h and hydrogen of 7.0 l/h (at ordinary temperature and ordinary pressure) were supplied after beginning the prepolymerization for 0.5 hours, and ethylene of 3.5 kg/h and hydrogen of 24.3 l/h (at ordinary temperature and ordinary pressure) were supplied after 0.5 hours from beginning the prepolymerization. This prepolymerization was totally carried out for 4 hours. After finishing the prepolymerization, ethylene and hydrogen gas were purged, the solid component were transferred to a drying drum, and dried with nitrogen. Then, a prepolymerization catalyst, in which 15.4 g of an ethylene polymer per 1 g of the solid catalyst component (1) was prepolymerized, was obtained.

### (3) Preparation of Polymer Particles Containing a Fluidity Improving Agent

Polymer particles containing a fluidity improving agent were obtained by mixing a powder of an ethylene and 1-hexene copolymer, and a polyoxyethylenelauryl ether acetate aqueous solution (KAO AKYPO RLM-45 produced by Kao Corporation, the ethyleneoxide average addition molar number=4.5) in a flask of 3 L for 10 minutes, and drying the mixture under vacuum at 60° C. for 6 hours. The polymer particles had the content of polyoxyethylenelauryl ether acetate of 5260 ppm.

### (4) Vapor Phase Polymerization

A continuous vapor-phase fluidized bed reactor was adjusted to have a total pressure of 2.0 MPa, a polymerization temperature of 87° C., and a holdup of 80 kg, and ethylene and 1-hexene were copolymerized in this reactor. As for a gas composition during a polymerization, ethylene was 92.7 mol %, hydrogen was 1.2 mol %, 1-hexene was 0.9 mol %, and nitrogen was 5.2 mol %. The prepolymerization catalyst obtained in Example 1 (2) was supplied at about 28 g/h, and triisobutylaluminum was supplied at 20 mmol/h. A polymer generating rate was about 19 kg/h, and the electrostatic charge amount in the vapor-phase fluidized bed reactor was about −900V (this amount was measured by the electrostatic voltmeter of S-21 produced by DITECH, LTD.).

In a state that the total pressure, the polymerization temperature, the holdup amount, the gas composition, and the taking-in amount of the prepolymerization catalyst and triisobutylaluminum were not changed, the polymer particles containing a fluidity improving agent prepared in Example 1 (3) of 319 g were taken into the vapor-phase fluidized bed polymerization reactor for 18 minutes, and the existence amount of polyoxyethylenelauryl ether acetate in the vapor-phase fluidized bed polymerization reactor was made to be 21 ppm by weight. The electrostatic charge amount in the vapor-phase fluidized bed reactor was about +100V, and the polymer generating rate was about 19 kg/h.

When the polyoxyethylenelauryl ether acetate was introduced into the vapor-phase fluidized bed reactor, the electrostatic charge amount was decreased, and thus fluidity of the polyolefin particle could be increased. Further, when the polyoxyethylenelauryl ether acetate was introduced, decreasing of polymerization activity was not confirmed.

### Comparative Example 1

### (1) Synthesis of a Solid Catalyst Component

A solid component (it will be described as a solid catalyst component (2) below) was obtained by a similar method for synthesizing a component (A) in Example 10 disclosed in Unexamined Japanese Patent Publication No. 2003-171415.

### (2) Preparation of a Prepolymerization Catalyst

The solid catalyst component (2) of Comparative example 1 (1) of 700 g was taken into an autoclave having an agitator, an inner capacity of 210 l, and being previously substituted by nitrogen. Then, butane of 80 l and hydrogen of 4 l (at ordinary temperature and ordinary pressure) were taken into the autoclave, and the autoclave was heated up to 19° C. Ethylene of 0.8 kg was taken in. After the inside of the system was stabilized, triisobutylaluminum of 315 mmol and racemic-ethylenebis(1-indenyl)zirconiumdiphenoxide of 105 mmol were taken in, and then a prepolymerization was begun. Ethylene of 2.2 kg/h and hydrogen of 7.5 l/h (at a normal temperature and a normal pressure) were supplied after beginning the prepolymerization for 0.5 hours, and ethylene of 4.5 kg/h and hydrogen of 37.9 l/h (at ordinary temperature and ordinary pressure) were supplied after passing 0.5 hours from beginning the prepolymerization. This prepolymerization was totally carried out for 2 hours. In addition, the temperature at the beginning of the prepolymerization was 24° C., and the temperature after finishing the prepolymerization was 28° C. After finishing the prepolymerization, ethylene and hydrogen gas were purged, the solid component was transferred to a drying drum, and dried with nitrogen. Then, a prepolymerization catalyst, in which 12.9 g of an ethylene polymer per 1 g of the solid catalyst component (2) was prepolymerized, was obtained. ps (3) Preparation of Polymer Particles Containing a Fluidity Improving Agent

Polymer particles containing a fluidity improving agent were obtained by mixing a powder of an ethylene and 1-hexene copolymer, and a lauryldiethanolamide (CHEMISTAT 2500 produced by Sanyo Chemical Industries, Ltd.) using a Henschel mixer (20 L SUPERMIXER Type SMV-20, produced by KAWATA MFG. CO., LTD.) at the rotating rate of 500 rpm for 2 hours. The polymer particles had the content of lauryldiethanolamide of 5000 ppm by weight.

### (4) Vapor Phase Polymerization

A continuous vapor-phase fluidized bed reactor was adjusted to have a total pressure of 2.0 MPa, a polymerization temperature of 75° C. and a holdup of 80 kg, and ethylene, 1-butene, and 1-hexene were copolymerized in this reactor. As for a gas composition during a polymerization, ethylene was 90.9 mol %, hydrogen was 0.5 mol %, 1-butene was 2.3 mol %, 1-hexene was 0.3 mol %, and nitrogen was 6.0 mol %. The prepolymerization catalyst obtained in Comparative example 1 (2) was supplied at about 35 g/h, and triisobutylaluminum was supplied at 25 mmol/h. A polymer generating rate was about 23 kg/h, and the electrostatic charge amount in the vapor-phase fluidized bed reactor was about −4000V (this amount was measured by the electrostatic voltmeter of S-21 produced by DITECH, LTD.).

In a state that the total pressure, the polymerization temperature, the holdup amount, the gas composition, and the taking-in amount of the prepolymerization catalyst and triisobutylaluminum were not changed, the polymer particles containing a fluidity improving agent prepared in Example 1 (3) of 275 g were taken into the vapor-phase fluidized bed polymerization reactor, and the amount of existence of lauryldiethanolamide in the vapor-phase fluidized bed polymerization reactor was made to be 17 ppm by weight. The electrostatic charge amount in the vapor-phase fluidized bed reactor was about −2200V, and the polymer generating rate was about 9 kg/h.

When the lauryldiethanolamide was introduced into the vapor-phase fluidized bed reactor, the electrostatic charge amount was decreased, and thus fluidity of the polyolefin particle could be increased. However, when the lauryldiethanolamide was introduced, largely decreasing of polymerization activity was confirmed.

### INDUSTRIAL APPLICABILITY

The present invention can provide a method for producing an olefin polymer by a vapor-phase fluidized bed reactor, and this method can provide an olefin polymer having proper fluidity of polyolefin particles and proper polymerization activity.

1. A method for producing an olefin polymer to polymerize olefin by supplying olefin and a catalyst for polymerizing olefin into a vapor-phase fluidized bed reactor, the method comprising:
introducing a fluidity improving agent comprising a compound represented by the following formula into the vapor-phase fluidized bed reactor,
[R—O—(AO)m—COO—]nY
(wherein, R represents an alkyl group, an alkenyl group, or an aryl group, AO represents an alkylene oxide group, m represents the average addition molar number of alkylene oxide, Y represents a hydrogen atom, an alkali metal atom, an alkaline earth metal atom, or an ammonium group, and n represents the valence of Y).

2. The method for producing an olefin polymer according to claim 1,
wherein the amount of the fluidity improving agent in the vapor-phase fluidized bed reactor is 0.01 to 1000 ppm by weight with respect to the total weight of a polymer in the fluidized bed reactor.

3. The method for producing an olefin polymer according to claim 1 or 2,
wherein the fluidity improving agent is introduced into the vapor-phase fluidized bed reactor by (1) coating the fluidity improving agent on an inner face of the vapor-phase fluidized bed reactor, (2) supplying polymer particles containing a fluidity improving agent into the vapor-phase fluidized bed reactor, and/or (3) introducing a liquid containing a fluidity improving agent into the vapor-phase fluidized bed reactor.

4. The method for producing an olefin polymer according to claim 3,
wherein the polymer particles containing a fluidity improving agent are particles containing a fluidity improving agent of 10 to 100000 ppm by weight with respect to the weight of a polymer in the polymer particles.

5. The method for producing an olefin polymer according to claim 1 or 2,
wherein the liquid containing a fluidity improving agent is introduced into seed polymer particles filled in the vapor-phase fluidized bed reactor before beginning a polymerization in the method to introduce the fluidity improving agent into the vapor-phase fluidized bed reactor.

6. The method for producing an olefin polymer according to claim 1,
wherein the catalyst for polymerizing a olefin polymer is a metallocene based catalyst.
